(19) United States
(12) Patent Application Publication
(10) Pub. No.: US 2016/0268115 A1
(43) Pub. Date: Sep. 15, 2016

(54) ION SOURCE SYSTEM FOR ATMOSPHERIC PRESSURE INTERFACE, AND MASS SPECTROMETER

(71) Applicant: BEIJING INSTITUTE OF TECHNOLOGY, Beijing (CN)

(72) Inventors: Wei XU, Beijing (CN); Cunjuan BIAN, Beijing (CN); Yanbing ZHAI, Beijing (CN); Xiang FANG, Beijing (CN); Xingchuang XIONG, Beijing (CN); You JIANG, Beijing (CN)

(21) Appl. No.: 15/029,398

(22) PCT Filed: Oct. 16, 2014
(86) PCT No.: PCT/CN2014/088733

§ 371 Date: Apr. 14, 2016

(30) Foreign Application Priority Data
Oct. 16, 2013 (CN) 201310485218.6

(51) Int. Cl. H01J 49/16

(52) U.S. Cl. CPC H01J 49/165

(57) ABSTRACT

Provided is an ion source system for an atmospheric pressure interface, comprising an atmospheric pressure ion source (1), wherein the atmospheric pressure ion source (1) is connected downstream to a vacuum ion source (2). Also provided is a mass spectrometer, using the present ion source system as an ion source. The present ion source system uses a combination of the atmospheric pressure ion source (1) and the vacuum ion source (2), is suitable for test sample having variety of forms, and performs secondary ionization on a sample to be tested, thus enhancing ion transmission efficiency. The present mass spectrometer significantly increases ion transmission efficiency, thus enabling continuous injection of samples and testing, and increasing the scanning speed of the spectrometer, particularly suitable for miniaturized mass spectrometer.

### TECHNICAL FIELD

The present invention relates to the field of mass spectrometry, in particular, to an ion source system for atmospheric pressure interface and mass spectrometer.

### BACKGROUND ART

Mass spectrometry is an analytical method by separating and detecting compounds according to different mass-to-charge ratios (m/z) to identify their compositions and structures. Mass spectrometry is a highly sensitive and highly selective biochemical analytic technique, and has been widely used in academic research, industrial product development, forensics, regulations, and other fields as a qualitative and quantitative means of chemical analysis. In recent years, especially after the crises of threats of chemical warfare and antiterrorism, food and environmental safety, space exploration and other major scientific and social events, there are dramatically increased needs for on-site chemical analysis in China and other countries throughout the world.

Ion sources working at atmospheric pressure (such as nano-ESI, ESI, APCI, DESI, LTP, etc.) has an advantage of convenient sample switching. In addition, these ion sources can be used as relatively independent modules that can be flexibly used in combination with various forms of mass analyzer, thereby receiving more and more attention. However, compared to vacuum ion sources (e.g. EI, CI, etc.), due to the need of a transition from atmospheric pressure to vacuum, an atmospheric pressure ion source mass spectrometer has lower transmission efficiency of ions. It is reported that the ion transmission efficiency between electrospray ionization and mass spectrometer is only in the range of 0.01%˜0.1%, while the transmission efficiency of atmospheric pressure matrix-assisted laser desorption ionization is lower.

When connected to an atmospheric pressure ion source, an atmospheric pressure interface has two main impacts on the mass spectrometer: 1) flow-limiting; 2) affecting ion transmission. Currently available ion mass analyzer (ion trap, time of flight, etc.) can only work in high vacuum conditions. In order to maintain a high degree of vacuum inside the mass spectrometer, the atmospheric pressure interface needs to effectively limit the amount of intake air in the mass spectrometer. Hence small aperture (125-1000 μm) capillary, cone and other air intake flow-limiting devices are widely used in the design of atmospheric pressure interface of a mass spectrometer. But those flow-limiting devices also severely limit the amount of intake air while decreasing the transmission efficiency of ions. The overall transmission efficiency of ions depends on the ion collection efficiency from the ion source to the inlet of the mass spectrometer and the ion transmission efficiency from the inlet of the mass spectrometer to the mass analyzer. First, small aperture flow-limiting devices limit the effective collection area of ions due to of its limited size; when ions enter the flow-limiting device, the coulomb forces between ions drive the ions to diffuse outward, resulting in secondary loss of ions; the ions having passing through the flow-limiting device is further subjected to a supersonic expansion effect produced by the high pressure difference at the outlet of the flow-limiting device, resulting in further defocusing of the ion beam.

To increase ion transfer efficiency, high-power vacuum system needs to be used to ensure that the vacuum chamber has a sufficient degree of vacuum, but this obviously cannot meet the requirements of miniaturizing mass spectrometer. Miniaturized mass spectrometer requires small and low-power vacuum system, and therefore its atmospheric pressure interface needs to have a stronger flow-limiting function, i.e. having a smaller aperture flow-limiting device, which inevitably reduces the collection area and the transmission efficiency of ions and has become an important factor impeding the development of miniaturized mass spectrometer with atmospheric pressure ion sources.

So far, miniaturized mass spectrometers have two ways of ionization: (1) internal ionization, where the ion source from the vacuum can only be used for gaseous samples; liquid or solid samples need to be gasified first, but the gasification process could easily lead to damages to the structure of the sample, resulting in a failure to obtain accurate analysis and test results. (2) external ionization. Due to the foregoing reasons regarding ion transmission efficiency and vacuum requirements, there exist very few miniaturized mass spectrometers of external ionization. So far, the only miniaturized mass spectrometer which can be combined with open atmospheric ion source is Mini 11 mass spectrometer based on discrete atmospheric pressure interface (DAPI) developed by Purdue University in 2008; however, in order to ensure the high degree of vacuum required by this type of mass spectrometer, samples can only be injected in a discontinuous manner, where the injection time is short, namely as short as about 8 ms, such that continuous injection detection mode cannot be attained and the scanning speed of the device is therefore limited.

### SUMMARY OF THE INVENTION

To overcome the various technical drawbacks such as low transmission efficiency of existing ion source mass spectrometer with atmospheric pressure interface, and existing vacuum ion source mass spectrometer being restricted by sample form, to find an ion source system for broader applicability, one object of the present invention is to provide an ion source system for atmospheric pressure interface.

Another object of the present invention is to provide a mass spectrometer.

The ion source system for an atmospheric pressure interface comprises an atmospheric pressure ion source, wherein the atmospheric pressure ion source is connected downstream to a vacuum ion source.

In the above mentioned ion source system, said atmospheric pressure ion source and said vacuum ion source are connected through a capillary or cone.

Preferably, said capillary is selected from capillaries with inner diameters of 50˜250 μm.

In the above mentioned ion source system, said atmospheric pressure ion source is electrospray ionization (ESI), nanoliter electrospray ionization (nano-ESI), atmospheric pressure chemical ionization (APCI), desorption electrospray ionization (DESI) or low temperature plasma ionization (LTP).

In the above mentioned ion source system, said vacuum ion source is electron impact ion source (EI), chemical ionization (CI), glow discharge electron impact ion source (GDEI), optical ion source, plasma discharge ionization or UV ionization.

The mass spectrometer according to the present invention comprises an ion source and a vacuum chamber, wherein said ion source is selected from an ion source system according to any one of the above mentioned technical solutions.

In the above mentioned mass spectrometer, said vacuum ion source in the ion source system can be disposed in the vacuum chamber of the mass spectrometer.

In the above mentioned mass spectrometer, said vacuum ion source in the ion source system can also be disposed in another vacuum chamber that is connected with the vacuum chamber of the mass spectrometer by a capillary or cone.

Preferably, said capillary is selected from capillaries with inner diameters of 50˜250 μm.

The ion source system and the corresponding mass spectrometer provided by the present invention effectively combine the atmospheric pressure ion source with the vacuum ion source for the first time. An injected sample undergoes two ionizations when going through the two ion sources in sequence. The present invention has the following advantages:

(1) The atmospheric pressure ion source serves as the primary ionization ion source, which allows the system to be used to detect gaseous, solid and other forms of samples, thus having wider applicability.

(2) The secondary ionization of the vacuum ion source can increase the number of ions that eventually go into the analysis and detection apparatus, thereby improving ion transmission efficiency.

(3) In the mass spectrometer of the present invention, the flow-limiting effect of atmospheric pressure ion source ensures the stability of the vacuum in the vacuum chamber of the mass spectrometer, and, because of the significant increase of the ion transmission efficiency, a low-power vacuum pump can meet the vacuum requirements of the mass spectrometer and realize continuous injections, thus improving the scanning speed of the instrument, particularly for miniaturized mass spectrometer.

(4) The mass spectrometer of the present invention can be obtained without substantial modification on the structure of currently available mass spectrometers, and therefore is easy to manufacture and has broad prospects in applications.

### BRIEF DESCRIPTION OF THE DRAWINGS

FIG. 1 is a schematic view of the structure of a mass spectrometer according to a second embodiment of the present invention;

FIG. 2 a schematic view of the structure of a mass spectrometer accordin to a third embodiment of the present invention;

FIG. 3 is a mass spectroscopy spectra obtained from a working example of the present invention;

Wherein, the reference numerals are annotated as follows: 1. atmospheric pressure ion source; 2. vacuum ion source; 3,4. vacuum chambers; 5. ion mass analyzer; 6. detector; 7. capillary; 8. cone; 9, 10. vacuum pump.

### DETAILED DESCRIPTION OF THE EMBODIMENTS

To make the objects, technical solutions, and advantages of the present invention become more apparent, certain exemplary embodiments of the technical solutions of the present invention are described below with the aid of the drawings. It is apparent that the embodiments described herein are only part but not all of embodiments of the present invention. The embodiments as described are merely for the purpose of illustrating but not limiting the scope of the invention. Based on the described embodiments of the present invention, other examples obtained by an artisan of ordinary skill in the art without creative efforts are within the scope of the present invention.

The first embodiment of the present invention provides an ion source system for an atmospheric pressure interface, which comprises an atmospheric pressure ion source and a vacuum ion source, wherein the atmospheric pressure ion source is connected downstream to a vacuum ion source.

When using this ion source system, a sample to be tested, which has been injected from one end of the atmospheric pressure ion source, first goes through the atmospheric pressure ion source for the first ionization and then go into the vacuum ion source. Due to charge loss during the transition from atmospheric pressure to vacuum, the sample entering into the vacuum ion source contains charged and uncharged ions, and goes into the vacuum ion source for the second ionization to produce a sample ready for detection that is almost completely ionized.

As a preferred technical solution, said atmospheric pressure ion source and said vacuum ion source are connected through a capillary or cone.

As a preferred technical solution, said capillary is selected from capillaries with inner diameters of 50˜250 μm.

As a preferred technical solution, said atmospheric pressure ion source may be any currently available atmospheric pressure ion sources, including but not limited to, electrospray ionization, nanoliter electrospray ionization, atmospheric pressure chemical ionization, desorption electrospray ionization or low temperature plasma ionization, etc.

As a preferred technical solution, said vacuum ion source may be any of currently available vacuum ion sources, including but not limited to, electron impact ion source, chemical ionization, glow discharge electron impact ion source, optical ion source, plasma discharge ionization or UV ionization.

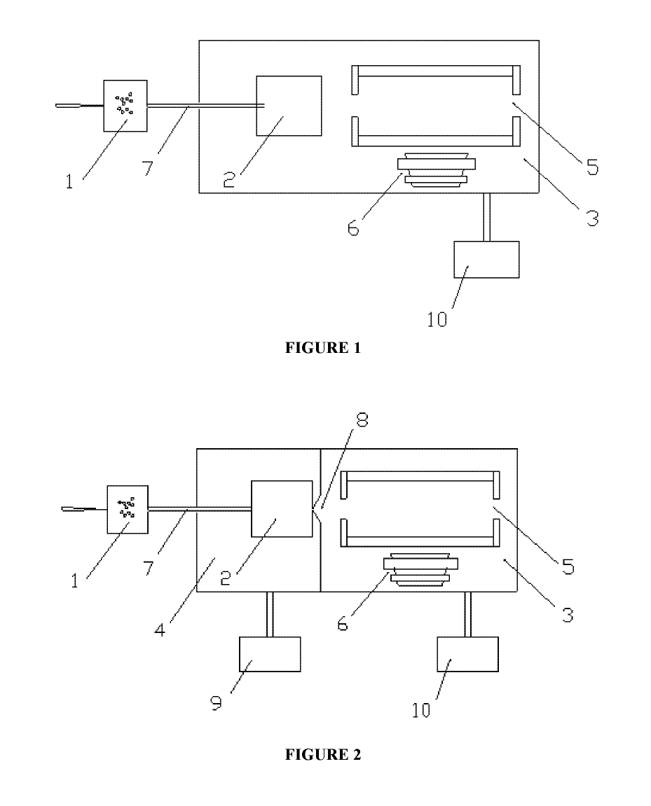

The second embodiment of the present invention provides a mass spectrometer, as shown in FIG. 1, where the atmospheric pressure ion source mass spectrometer comprises atmospheric pressure ion source 1 and vacuum chamber 3; ion mass analyzer 5, and where detector 6 and other conventional analysis and detection equipments are disposed in the vacuum chamber 3, the vacuum degree in the vacuum chamber 3 is provided by a low power vacuum pump 10. Also equipped in the vacuum chamber 3 is a vacuum ion source 2, which is connected to the atmospheric pressure ion source 1 through capillary 7 (which can also be a cone).

As a preferred technical solution, the capillary is selected from capillaries with inner diameters of 50˜250 μm.

As a preferred technical solution, said atmospheric pressure ion source may be any of currently available atmospheric pressure ion sources, including but not limited to, electrospray ionization, nanoliter electrospray ionization, atmospheric pressure chemical ionization, desorption electrospray ionization or low temperature plasma ionization, etc.

As a preferred technical solution, said vacuum ion source may be any of currently available vacuum ion sources, including but not limited to, electron impact ion source, chemical ionization, glow discharge electron impact ion source, optical ion source, plasma discharge ionization or UV ionization.

When using this mass spectrometer to detect samples, a sample first enters the atmospheric pressure ion source 1 from an injection port for the first ionization. The resulting ions from the first ionization then go into vacuum chamber 3 through the atmospheric pressure interface such as capillary 7. Some of the ions will lose charges at this stage, but the molecules in the original sample still exist. The ions and molecules in vacuum chamber 3 then enter vacuum ion source 2 for the second ionization. The resulting ions after the second ionization then go into mass analyzer 5, detector 6, etc. in sequence for analysis and detection.

The third embodiment of the present invention provides a mass spectrometer, as shown in FIG. 2, where the atmospheric pressure ion source mass spectrometer comprises atmospheric pressure ion source 1 and vacuum chamber 3; ion mass analyzer 5, and where detector 6 and other conventional analysis and detection equipments are equipped in the vacuum chamber 3, the vacuum degree in the vacuum chamber 3 is provided by a low power mechanical vacuum pump 10. A vacuum ion source 2 is also disposed between the atmospheric pressure ion source 1 and the vacuum chamber 3, the vacuum ion source 2 being connected to the atmospheric pressure ion source 1 through capillary 7 (which can also be a cone). The vacuum ion source 2 is disposed in a separate vacuum chamber 4 which is connected to the vacuum chamber 3 through a cone 8 (which can also be a capillary), and the vacuum degree in the vacuum chamber 4 is provided by a low power vacuum pump 9.

As a preferred technical solution, the capillary is selected from capillaries with inner diameters of 50˜250 μm.

As a preferred technical solution, said atmospheric pressure ion source may be any of currently available atmospheric pressure ion sources, including but not limited to, electrospray ionization, nanoliter electrospray ionization, atmospheric pressure chemical ionization, desorption electrospray ionization or low temperature plasma ionization, etc.

As a preferred technical solution, said vacuum ion source may be any of currently available vacuum ion sources, including but not limited to, electron impact ion source, chemical ionization, glow discharge electron impact ion source, optical ion source, plasma discharge ionization or UV ionization.

When using this mass spectrometer to detect samples, a sample first goes into the atmospheric pressure ion source 1 from an injection port for the first ionization. The resulting ions then enter vacuum chamber 4 through atmospheric pressure interface capillary 7. Some ions will lose charges at this stage, but the molecules in the original sample still exist. The ions and molecules in the vacuum chamber 4 then enter vacuum ion source 2 for the second ionization. The resulting ions after the second ionization then go into mass analyzer 5, detector 6, etc. in the vacuum chamber 3 in sequence for analysis and detection.

### EXAMPLES

The mass spectrometer shown in FIG. 1 is used, wherein, atmospheric pressure ion source is Nano-ESI ion source, vacuum ion source is plasma discharge device, the interface between the atmospheric pressure ion source and the vacuum ion source is stainless steel capillary with an inner diameter of 125 μm, the vacuum in the vacuum chamber is in the range of 1-10 Torr, the above vacuum requirement can be met by a small vacuum pump.

After injection, samples to be tested go into the atmospheric pressure ion source for the first ionization, then go into the plasma discharge device through a stainless steel capillary for the second ionization before detection. The samples to be tested are rhodamine b (A) and reserpine (B). As these samples are solids, conventional vacuum ion source mass spectrometers cannot be used for detection.

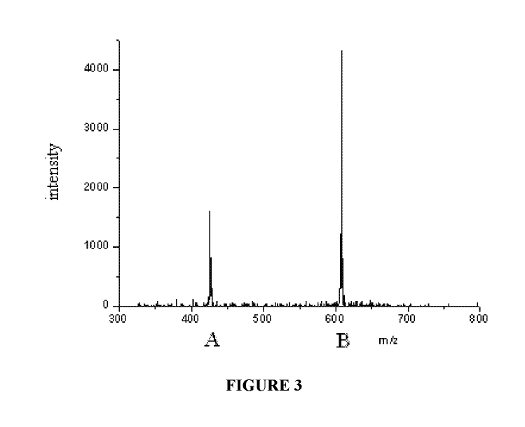

Using the mass spectrometer of the present invention for detection, the resulting spectrum is shown in FIG. 3. When the plasma discharge device is powered off, the instrument is in a state that only relies upon the external atmospheric pressure ion source to ionize the samples, and nothing can be observed. This indicates that the ion transmission efficiency of the ion source with an atmospheric pressure interface is very low, such that almost no ions are transmitted to reach the analysis and detection apparatus, thus no characteristic peaks can be observed on the spectrum. When the mass spectrometer according to the present invention is used, a sample is subjected to two time ionizations, and at a relatively low degree of vacuum, ion transmission efficiency can be significantly improved. Thus, the mass spectrometer according to the present invention is suitable to detect non-gaseous samples.

Although the invention has been generally described above and by way of specific embodiments, certain modifications and improvements are obvious for the skilled in this art on the basis of the present invention. Hence, all these modifications or improvements without departing from the spirit of the present invention fall into the scope of the invention.

1. An ion source system for an atmospheric pressure interface, comprising an atmospheric pressure ion source, wherein the atmospheric pressure ion source is connected downstream to a vacuum ion source.

2. The ion source system according to claim 1, wherein said atmospheric pressure ion source and said vacuum ion source are connected through a capillary or a cone.

3. The ion source system according to claim 2, wherein said capillary is selected from capillaries with inner diameters of 50˜250 μm.

4. The ion source system according to claim 1, wherein said atmospheric pressure ion source is an electrospray ionization, nanoliter electrospray ionization, atmospheric pressure chemical ionization, desorption electrospray ionization or low temperature plasma ionization.

5. The ion source system according to claim 1, wherein said vacuum ion source is electron impact ion source, chemical ionization, glow discharge electron impact ion source, optical ion source, plasma discharge ionization or UV ionization.

6. A mass spectrometer, comprising an ion source and a vacuum chamber, wherein said ion source comprises an ion source system according to claim 1.

7. The mass spectrometer according to claim 6, wherein said vacuum ion source in the ion source system is disposed in a vacuum chamber of the mass spectrometer.

8. The mass spectrometer according to claim 6, wherein said vacuum ion source in the ion source system is disposed in a second vacuum chamber that is connected with a vacuum chamber of the mass spectrometer by a capillary or cone.

9. The mass spectrometer according to claim 8, wherein said capillary is selected from capillaries with inner diameter of 50˜250 μm.
